(19) United States
(12) Patent Application Publication
(10) Pub. No.: US 2004/0262941 A1
(43) Pub. Date: Dec. 30, 2004

(54) Track cover

(76) Inventor: Randy Johnson, Snohomish, WA (US)

Correspondence Address: DEAN A. CRAINE, P.S., STE 140, 400 - 112TH AVE NE, BELLEVUE, WA, 98004, US

(21) Appl. No.: 10/823,070

(22) Filed: Apr. 13, 2004

Related U.S. Application Data
(60) Provisional application No. 60/462,639, filed on Apr. 14, 2003.

(51) Int. Cl. B60P 7/02

(52) U.S. Cl. 296/100.01

(57) ABSTRACT

A track cover that is quickly and easily installed on different sizes and shapes of tracks on track vehicles that prevents dirt, gravel, or other debris may be thrown from the track of a track-type work vehicle while being transported onto the roadway. The track cover includes a flexible, elongated body designed to fit over the top and side surfaces and the side opening on a track. Attached to the lower edge of the elongated body is a durable mat that, during use, is placed over the path area of a trailer which the track vehicle is driven. Elastic cords attached at one end to the inside edge of the track, extend over the top, front, and side surfaces of the track and connect to the perimeter edge of the elongated body to hold the elongated body on the track and to keep dislodged dirt, gravel, or other debris from falling into the roadway.

This utility patent application is based on the provisional patent application (Ser. No. 60/462,639) filed on Apr. 14, 2003.

### BACKGROUND OF THE INVENTION

1. Field of the Invention

This invention relates to track-type work vehicles and, more particularly, to an apparatus for covering the tracks on a track driven work construction vehicle as the vehicle is transported on a trailer.

2. Description of the Related Art

Earthmoving and construction vehicles that utilize endless chain tracks to support and propel the vehicle on soil are often moved from one worksite to another on a trailer or flatbed truck. When transporting the construction vehicle on roadways, dirt, gravel, and other debris stuck on the vehicle's tracks may be dislodged and dropped onto the roadway, potentially causing serious driving hazards and damage to other vehicles.

What is needed is a cover that can be quickly and easily installed over the vehicle's tracks to prevent dislodged dirt, gravel, and other debris from falling onto the roadway.

### SUMMARY OF THE INVENTION

It is an object of the present invention to provide an effective, inexpensive cover that can be quickly and easily installed on the track on a track driven work construction vehicle.

It is another object of the present invention to provide such a cover that securely attaches to the track and cannot be easily detached when the vehicle is transported on a trailer or the flatbed of a truck.

This and other objects of the present invention are met by a track cover that includes an elongated body designed to cover the side opening and exposed top and end surfaces of the track. Attached to the lower edge of the elongated body is a durable mat that is placed over the area on the trailer or flatbed where the tracks on the vehicle are driven. During use, two track covers are selected with their mats longitudinally aligned on opposite sides of the trailer or flatbed. The tracks on the vehicle are driven over the mats so that the weight of the vehicle holds the two track covers on the trailer or flatbed. The two elongated bodies which hang downward over the sides of the trailer are then pulled upward over the side openings and exposed surfaces of the adjacent track. Attached to the upper, front and rear edges on each elongated body is a plurality of straps designed to extend transversely over the track to securely hold the elongated body over the exposed surfaces. Optional pleats may be formed in the elongated body that enables the elongated body to selectively conform to tracks having different sizes and shapes.

### DESCRIPTION OF THE DRAWINGS

FIG. 1 is a side elevational view of a track vehicle loaded onto a trailer with the track cover shown attached to a track.

FIG. 2 is a perspective view of the track cover attached to cover a track.

FIG. 3 is a top plan view of the track cover attached to a track.

FIG. 4 is a side elevational view of the track cover.

FIG. 5 is a top plan view of the track cover showing the inside edge of the mat attached to the lower edge of the body.

FIG. 6 is a sectional side elevational view of the mat and the belt and body.

FIG. 7 is a sectional side elevational view of the D-rings and belt attached to the upper edge of the body and extended over the track.

FIG. 8 is a side elevational view of the second embodiment of the track cover.

### DESCRIPTION OF THE PREFERRED EMBODIMENT(S)

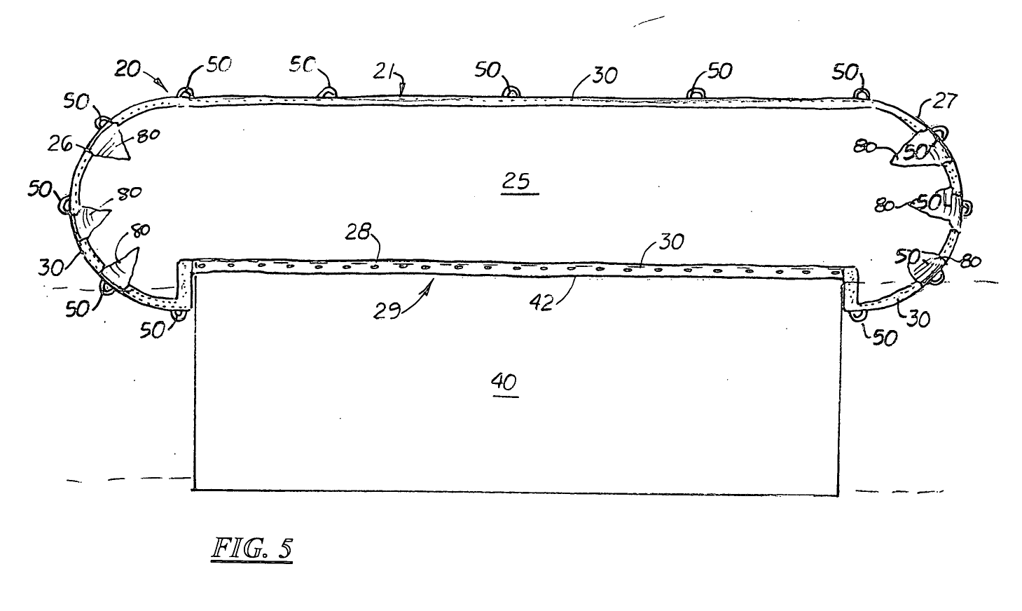

Referring to the accompanying Figures, there is shown and described a track cover 10 designed to be quickly and easily installed on a wide range of construction vehicles 90 with the tracks 92 to prevent dirt, gravel, and other debris, generally referenced as 100, from being thrown from the track 92 onto the roadway 67 while being transported behind a hauling vehicle 90. The track cover 10 includes a flexible, elongated body 20 designed to fit closely over the side opening 93 and exposed top and end surfaces 95, 96 of the track 92. Attached to the lower edge 24 of the elongated body 20 is a durable mat 40 that, during use, is placed over the path on the trailer bed where a track 92 is driven, as shown in FIG. 5. Elastic cords 60 attached at one end to the inside edge of the track 92, extend over the track 92 and connect at one end to the perimeter edges on the elongated body 20 to hold the elongated body 20 in place on the track 92, thereby, keeping dislodged gravel, mud and debris 100 from falling into the roadway 67.

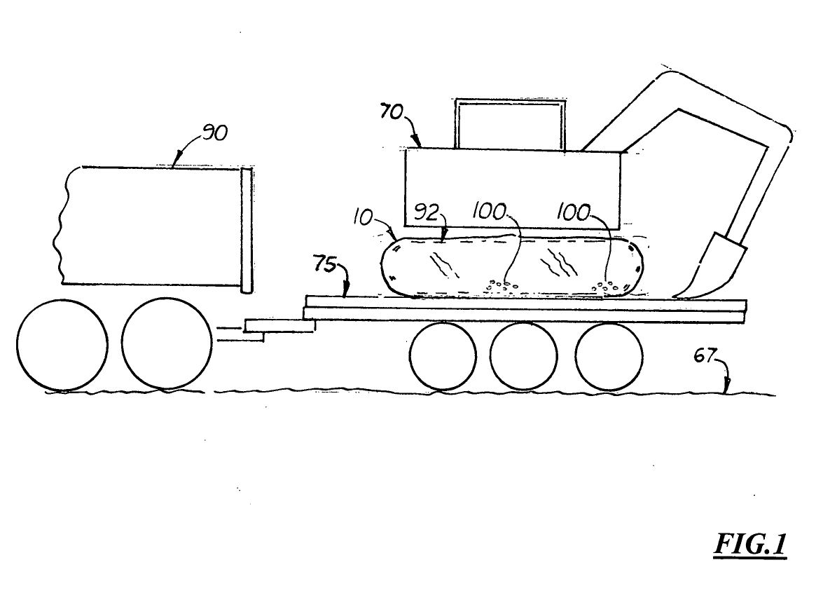

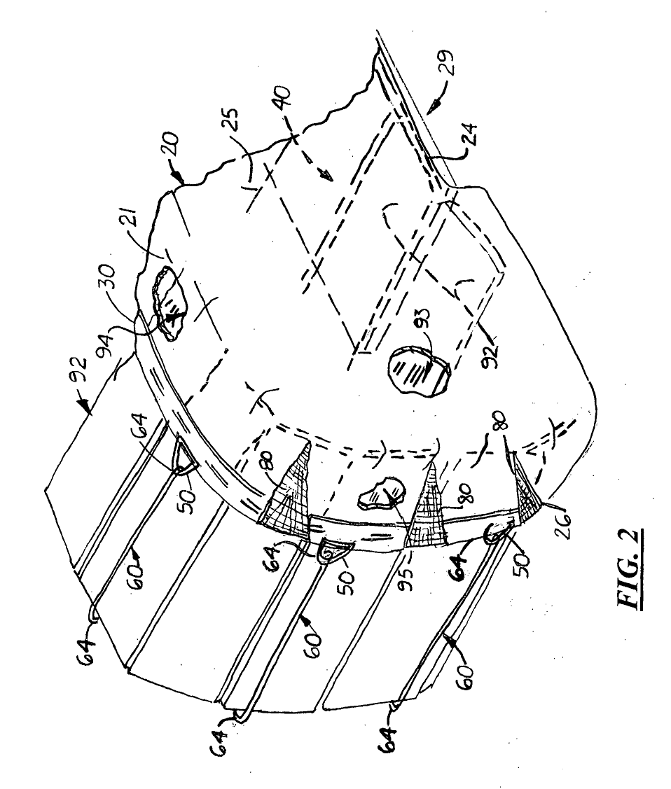

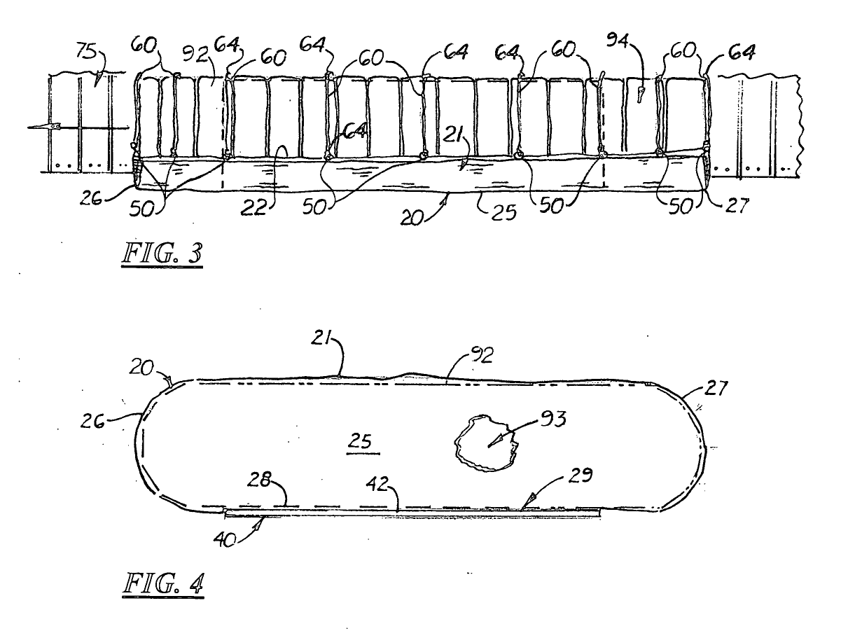

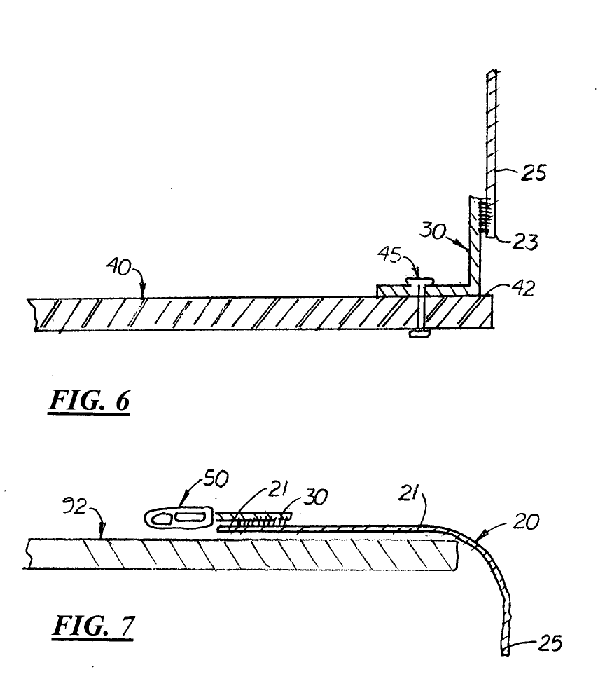

In the preferred embodiment, the elongated body 20 includes a horizontal upper section 21, and a vertical middle section 25. As shown in FIG. 3, the upper section 21 includes a straight perimeter edge 22 that is integrally attached to the opposite curved side sections 26, 27. The upper section 21 is sufficient in width and length to extend 6 to 12 inches over the top surface 95 of the track 92. The middle section 25 is sufficient in length to partially wrap around the front and rear surfaces of the track 92 and to completely cover the side opening 93 on the track 92. Formed on the lower edge 28 of the middle section 25 is a cut out area 29 designed to receive the inside edge 42 of the mat 40. In the embodiment shown in FIGS. 1-7, the upper and middle and side sections 21, 25, 26, 27 respectively, are made of 18-ounce vinyl and measure approximately 13.5 feet by 3 feet (Length×Width). The cut out area 29 measures approximately 11.3 feet by 0.5 feet (Length×Width).

Attached or sewn to the perimeter edges of the upper and middle, and side sections 21, 25, 26, 27 respectively, and to the lower edge 28 is a durable web belt 30 designed to provide a durable edge that resists wear. In the preferred embodiment the web belt 30 is made of flexible nylon and is approximately two inches wide.

As shown in FIG. 5, the mat 40 is attached along its inside edge 42 of the mat 40 by rivets 45 which are evenly spaced apart along the inside edge 42. In the embodiment shown in FIG. 1-5, the mat 40 measures approximately 11.2 feet by 2 feet (Length×Width) and is made of heavy-duty rubber approximately 3/8 inch thick.

Evenly spaced apart along the perimeter edges of the upper and middle sections and side sections 21, 25, 26, 27 respectively, is a plurality of D-rings 50. During use, elastic cords 60 attach to the D-rings 50 and extend transversely over the upper and side sections 21, 26, 27 of the elongated body 20 to hold the track cover 10 in place on a track 92. Attached to the opposite ends of the elastic cords 60 are hooks 64 that connect to the D-rings 50 and to the inside edge 97 of the track 92. In the embodiment shown in FIGS. 1, the elastic cords 60 measure approximately 12 inches when stretched.

Optional pleats 80 may be formed in the side sections 26, 27 of the elongated body 20 that enable the elongated body 20 to selectively conform around tracks having different shapes and sizes. In the preferred embodiment the pleats 80 are triangular in shape and made of durable elastic material. There are three pleats 80 evenly spaced apart and formed on each side section 26, 27.

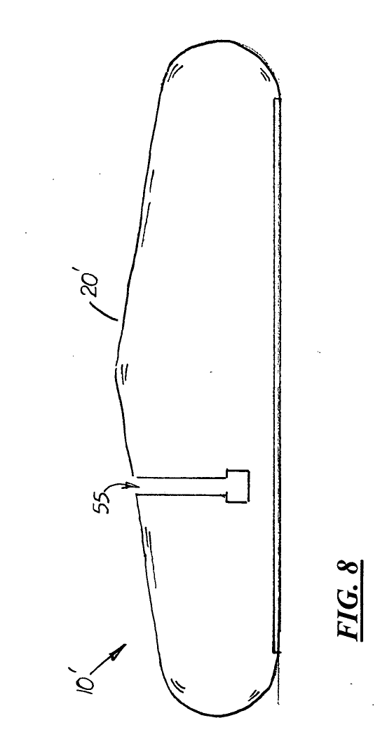

FIG. 8 shows a second embodiment of the track cover 10′ that includes an elongated body 20′ designed to cover a track 92′ with an elevated center axis 100. The elongated body 20′ has a shape that matches the track 92′. The elongated body 20′ also includes an optional slot 55 designed to receive a structural member (not shown) that extends laterally from the track 92′.

In use, two track covers are selected and longitudinally aligned and placed on opposite sides of the trailer or flatbed. The two mats 40 are longitudinally aligned and placed on opposite sides of the trailer of flatbed. The two elongated bodies 20 extend downward over the sides of the trailer or truck. The track vehicle 90 is driven onto the trailer 75 or flatbed, so that the two tracks 92 are located directly over the two mats 40. The weight of the track vehicle 90 holds the mats 40 on the trailer 75 or flatbed. The two elongated bodies 20 are then pulled upward and extended over the side opening 93 and exposed top and end surfaces 95, 96 of the tracks 92 and then secured by attaching the hooks 64 of the elastic cords 60 to the D-rings 50 and inside edge of the track 92.

When not in use, the track cover 10 can be folded into a compact configuration and stored on the trailer or truck for later use.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A track cover, comprising:
a. an elongated body capable of partially covering the top and opposite side sections and the side opening of a track on a track vehicle, said elongated body including a lower edge;
b. a durable mat attached to said lower edge on said elongated body; and,
c. a plurality of elastic straps used to attach said elongated body over the top and side surfaces of the track on the track vehicle when said elongated body is placed over the track.

2. The track cover, as recited in claim 1, further including a belt attached to the perimeter edges of said elongated body.

3. The track cover, as recited in claim 2, further including at least one pleat formed on said elongated body that enable said elongated body to adjust in size and shape to the track on a track vehicle.

4. The track cover, as recited in claim 1, wherein said elongated body includes an upper section that partially extends over the top surface of the track on a track vehicle.

5. The track cover, as recited in claim 1, wherein said elongated body is made of vinyl.

6. The track cover, as recited in claim 5, wherein said vinyl is 18 oz.

7. The track cover, as recited in claim 1, further including a cut out area formed on the lower edge of said elongated body, in which the perimeter edge of said mat extends.

8. The track cover, as recited in claim 1, wherein said mat is made of rubber.

9. The track cover, as recited in claim 1, further including a plurality of D-rings attached to the perimeter edge of said elongated body that connect to said elastic straps to hold said elongated body over the track.

10. The track cover, as recited in claim 1, wherein said elongated body includes an elevated center axis that enables said elongated body to be used on a track with an elevated center axis.

11. The track cover, as recited in claim 1, further including slots formed on said elongated body to allow structural members to extend through said elongated body when attached over the track.

12. A track cover, comprising:
a. an elongated body capable of fitting over the track of a track vehicle, said elongated body including an upper section, a middle section, and two opposite side sections;
b. a belt is sewn to the perimeter edges of said upper section, said middle section and said end sections;
c. a mat is attached to the lower edge of said elongated body;
d. a plurality of D-rings are attached to the perimeter edges of said elongated body; and,
e. a plurality of elastic cords that connect at one end to said D-rings and extend across the tracks and connect to the inside edges of said track to hold said elongated body over a track.

13. The track cover, as recited in claim 12, further including a belt attached to the perimeter edges of said elongated body.

14. The track cover, as recited in claim 12, further including at least one pleat formed on said elongated body that enable said elongated body to adjust in size and shape to the track on a track vehicle.

15. The track cover, as recited in claim 12, wherein said elongated body is made of vinyl.

16. The track cover, as recited in claim 12, wherein said vinyl is 18 oz.

17. The track cover, as recited in claim 12, further including a cut out area formed on the lower edge of said elongated body, in which the perimeter edge of said mat extends.

18. The track cover, as recited in claim 12, wherein said mat is made of rubber.

19. The track cover, as recited in claim 12, wherein said elongated body includes an elevated center axis that enables said elongated body to be used on a track with an elevated center axis.

20. A method for preventing debris from the tracks on a track work construction vehicle from falling onto the roadway when transporting the construction vehicle on a trailer or the bed of a transport vehicle comprising the following steps:
a. selecting at least one track cover that includes an elongated body that fits over the track on a track vehicle, said elongated body being sufficient in size and shape to over the side opening on the track, said elongated body including a longitudinally aligned mat attached to a lower perimeter edge;
b. positioning track over on the trailer or bed of a transport vehicle so that said mat is longitudinally aligned on the trailer or bed of a transport vehicle and by driven upon by the track of a track vehicle when the track vehicle is transported on the trailer or bed of a transport vehicle, said elongated body being disposed over the side of the trailer or bed;
c. extending said elongated body over the side opening and the top surface of the track located on said matt; and,
d. securely attaching said elongated body over the track.
